(19) United States
(12) Patent Application Publication
(10) Pub. No.: US 2024/0247687 A1
(43) Pub. Date: Jul. 25, 2024

(54) COMPOSITE MATERIAL CAGE FOR A ROLLING BEARING

(71) Applicants: AKTIEBOLAGET SKF, GOTEBORG (SE); SKF Aerospace France S.A.S, Montigny-le-Bretonneux (FR)

(72) Inventors: Florent Denis FAUCHERY, Montmeyran (FR); Florian Vincent BARDY, Perrigny (FR); Anthony Roger Jeannot JEROME, Valence (FR); Valentin Roger Claude FLEURY, Romans-sur-Isère (FR); Thomas KRAUSE, Grafenrheinfeld (DE)

(21) Appl. No.: 18/414,751

(22) Filed: Jan. 17, 2024

(30) Foreign Application Priority Data
Jan. 24, 2023 (FR) 2300639

(51) Int. Cl. F16C 33/44

(52) U.S. Cl. CPC F16C 33/44; F16C 2208/86

(57) ABSTRACT

A cage for a rolling element bearing is intended to ensure the circumferential spacing of at least one row of rolling elements and includes a plurality of pockets to accommodate the rolling elements of the row. The cage is made of a fiber-reinforced synthetic material having a glass transition temperature equal to or greater than 120° Celsius.

### CROSS-REFERENCE

This application claims priority to French patent application no. 20300639 filed on Jan. 24, 2023, the entire contents of which are fully incorporated herein by reference.

### BACKGROUND OF THE INVENTION

The present invention relates to the cages for bearings with rolling elements, to rolling bearings provided with such cages and rolling elements, and to methods for forming these cages.

Rolling bearings with rolling elements are components that are intended to guide and connect various mechanical parts in rotation. These rolling bearings generally comprise an inner ring and an outer ring, the rolling elements being disposed between the two rings. The rolling elements, which may be balls, cylindrical rollers, conical rollers or needle rollers, are often held or retained by a cage.

Conventionally, such cages are made in one piece by molding of a synthetic material. To provide a cage with sufficient mechanical strength, the synthetic material typically comprises a matrix in which fibers are embedded. The matrix may be, for example, a phenolic resin and the fibers may be cotton fibers or another appropriate material.

Such a cage made of synthetic material is lightweight, inexpensive to manufacture, and provides good retention of the rolling elements. Consequently, the rolling bearings equipped with these cages are generally satisfactory. As such, for common usage or typical applications, these rolling bearings have a sufficient service life and essentially retain their mechanical properties, such as the guiding precision.

However, it has been observed that the performance of a rolling bearing equipped with such a synthetic cage may be impaired under certain use conditions. When a rolling bearing is subjected to very high rotational speeds, when used for example in certain machine-tool spindles, the cage can deteriorate, sometimes to the point of breakage. Specifically, the high rotational speeds cause increases in temperature and excessive temperatures may lead to a decrease in the mechanical strength of the cage, particularly the rigidity of the cage. This phenomenon generally occurs at temperatures close to the glass transition temperature of the cage matrix, which is about 80° C. for phenolic resin, at which temperature the fundamental mechanical properties of a cage are reduced. This glass transition temperature value is a glass transition threshold. In addition, high rotational speeds generate relatively substantial stresses, in particular due to centrifugal force, thus increasing the risk of degradation or breakage of the cage.

Another condition which may lead to impairment of, or damage to, the cage is an excessive humidity level during operating conditions; in other words, a level or amount of humidity beyond the nominal degree or mean degree generally observed. Such a humidity level may be due to wet weather, a specific application environment, a more or less aqueous lubricant, or other factor(s). As is known in bearing manufacturing, the matrix of a bearing cage is capable of retaining a certain quantity of water and this retention phenomenon is more pronounced or increased at higher degrees of humidity. Also, the more the cage retains water, the greater the amount of deformation of the cage, and in some instances, the cage deformation is so excessive that the cage dimensions exceed desired manufacturing tolerances. Such deformation results in a more rapid deterioration of the cage.

Alternatively, a cage may also be impaired by an insufficient humidity level, that is to say, a humidity below the nominal degree or mean degree generally observed in a bearing application. This insufficient humidity level may be due to very dry weather, a specific application environment, insufficient lubrication, or some other factor(s). If the cage does not retain enough water, that is to say in practice if the cage is operating in an environment in which the degree of humidity has dropped too much, a cage may be subject to deformation conditions that may cause dimensions of the cage to exceed a desired range of the manufacturing tolerances. Thereby, a more rapid deterioration of the cage may occur.

Thus, bearing cages that are conventionally used are often too sensitive to the ambient degree of humidity and deteriorate too quickly if the application temperatures of the rolling bearing are high.

### SUMMARY OF THE INVENTION

A general aim of the present invention is to improve the service life of cages made of synthetic material for rolling bearings with rolling elements. Generally, it is desired to preserve the mechanical properties of the cages for a vast majority of the use conditions or applications of a rolling bearing.

More precisely, the present invention seeks to reduce, or even eliminate, the influence of the degree of humidity in the operating conditions of a rolling bearing. The present invention also has the goal of enabling a rolling bearing to operate under relatively high temperature conditions.

To achieve these goals, the present invention proposes a cage for a rolling bearing, intended to ensure the circumferential spacing of at least one row of rolling elements, the cage comprising a plurality of pockets to accommodate the rolling elements of the row and being made of a fiber-reinforced synthetic material. According to the present invention, the synthetic material has a glass transition temperature equal to or greater than 120° C.

As discussed above, below its glass transition temperature, a synthetic material retains its mechanical properties such as hardness or rigidity. However, above the transition temperature, the synthetic material becomes much more flexible, even viscoelastic. Consequently, with the cage of the present invention, the rolling bearing can be subjected to relatively high rotational speeds when the resultant heating temperature, as determined by a particular application, remains in a range of 80° C. to 120° C. and thus does not exceed the transition temperature. The cage retains its mechanical properties, its shape remains much more stable and the dimensions of the cage remain within desired manufacturing tolerances.

In one embodiment of the present invention, the synthetic material is an epoxy resin, the glass transition temperature of which is between 130° C. and 200° C. Such a relatively high glass transition point is particularly advantageous because it not only permits use in a large range of temperatures in the usual sense of the phrase, but also constitutes an additional level of security or safety in the event of spot heating, which may occur due to an anomaly or other factor.

Preferably, the reinforcing fibers are continuous, that is to say, placed layer by layer as opposed to being cut or chopped fibers. Such continuous fibers allows a uniform distribution of the fibers. Another advantageous aspect of the present invention is to place the fibers in a circumferential direction. This results in greater structural homogeneity of the cage and greater rigidity.

In a particular embodiment, the fibers comprise carbon fibers. As an alternative or in combination, the fibers may comprise glass fibers, permitting a reduction in cost of the cage, and/or Kevlar® fibers and/or flax fibers and/or Vectran® fibers, in order to improve the vibratory properties of the cage.

The present invention also relates to a rolling bearing comprising a cage as defined above. The invention further relates to a method of manufacturing cages for rolling bearings, the cages being made of fiber-reinforced synthetic material and comprising a plurality of pockets, the method comprising:
a step of producing a cylindrical tube preform by winding continuous fibers pre-impregnated with the synthetic material, the glass transition temperature of which is equal to or greater than 120° C., on a mandrel;
a step of molding and polymerizing the tube; and
a step of cutting the formed tube so as to form rings each having desired dimensions of a cage.

After completion of the last step described above, each formed ring has outer and inner diameters within the required dimensions of the finished cage. As such, there is no need to conduct any further machining of these diameters. However, it is possible to provide a final step of polishing the inner and outer surfaces of the cage, in order to remove the free particles and optimize the roughness. The cage may then be washed to ensure delivery without any fiber or resin particles.

Conventional winding techniques may be used, for example, to produce the preform. The molding may be effected or occur in a mold in two or more parts, which are then joined so as to delimit a cylindrical volume for accommodating the preform on the shape. The tube may be cut by an automatic saw, by a conventional manually-operated lathe or a lathe with digital control, by high-pressure water jet, or any other suitable means.

According to one mode of implementation of the present invention, the method further comprises a step of forming pockets on the cut rings so as to obtain the finished cages. Alternatively, the pockets may be formed after the molding and polymerization step, but before the step of cutting the formed tube. Such a step of forming the pockets may be carried out, for example, by machining.

According to another mode of implementation of the present invention, the method comprises a step of forming the pockets during the step of molding and polymerizing the tube. Such formation of the pockets during the step of producing the preform may occur, for example, by using a mandrel equipped with circumferential rows of protrusions extending radially outwardly, each row of protrusions comprising a plurality of protrusions spaced apart from one another in the circumferential direction, the rows being spaced apart axially from one another.

The pockets are thus obtained directly by preforming and then molding. For certain applications requiring a high degree of precision, it is nevertheless possible to provide a step of finishing the pockets by removal of material or by over-injection of material.

According to a particular mode of implementation, at least some of the fibers, or all of the fibers, form a non-zero angle with respect to the axis of the cylindrical shape. The fibers are positioned, for example, by winding, thus providing regularity to their distribution and therefore dimensional homogeneity in a series of cages.

According to a particular mode of implementation, the fibers may be made of carbon and the synthetic material is an epoxy resin which has a glass transition temperature of between 130° C. and 200° C. Such a high level of the glass transition point provides the cages with mechanical stability for all intended uses, whether conventional or extreme. The carbon fibers make the cage very mechanically strong, and also very lightweight.

In a complementary manner, a layer of thermosetting synthetic material may be disposed at the periphery of the tube. This material may be, for example, a polyurethane or any equivalent material. This type of material provides the cage with damping properties. Consequently, vibrations and operating noises are thereby reduced.

### BRIEF DESCRIPTION OF THE SEVERAL VIEWS OF THE DRAWINGS

Further aims, features and advantages of the invention will become apparent from reading the detailed description of non-limiting embodiments, with reference to the appended figures, in which:

FIG. 1 is a side view of a tube obtained by winding of fibers on a mandrel for the manufacture of cages according to a first mode of implementation of the invention;

FIG. 2 is a perspective view of a cage for a rolling bearing with rolling elements that is obtained according to the embodiment in FIG. 1; and

FIG. 3 is a perspective view which corresponds to another mode of implementation of the production method of the invention.

### DETAILED DESCRIPTION OF THE INVENTION

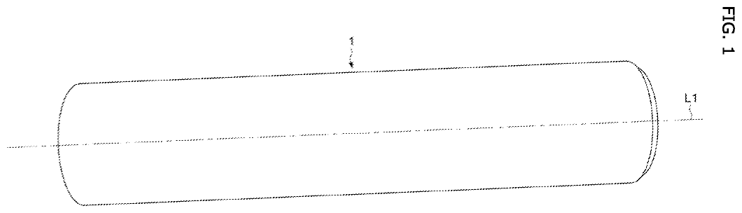

FIG. 1 schematically shows a hollow tube 1 having a longitudinal axis L1. This hollow tube 1 is obtained from a cylindrical preform of the tube 1, the preform being produced by winding continuous fibers pre-impregnated with a synthetic material about a mandrel, the glass transition temperature of the synthetic material being equal to or greater than 120° C.

For example, the fibers are disposed or arranged in the form of layers by known techniques such as winding, winding of a woven fiber fabric, or any equivalent. The orientation of the fibers of each layer and the number of superposed layers are determined depending on the desired structural and vibratory features of the cage being manufactured.

The fibers are preferably carbon fibers. As an alternative or in combination, the fibers may comprise glass fibers, Kevlar® fibers, flax fibers, Vectran® fibers or other fibers. The fibers may thus be used as only a single fiber type or as a combination of different types of fibers. The selection of the particular materials depends upon the desired mechanical properties of a finished bearing cage 2, and may also depend on economic considerations (i.e., material costs). The synthetic material is preferably an epoxy resin, the glass transition temperature of which is between 130° C. and 200° C.

Then, after a first step of producing the preform, a step of molding and polymerizing the tube 1 under particular temperature and pressure conditions adapted to the composite material used is carried out. This step provides the tube 1 with all its desired properties, particularly shape stability and mechanical strength.

For more details regarding the step of producing the preform and the molding and polymerization step, reference may be made to French patent publication no. FR 3053624A1 published on Jan. 12, 2018, which is incorporated in its entirety herein by reference.

From an obtained or formed tube 1, provision is made of a cutting step so as to form rings or annular bodies each having the desired dimensions of a cage 2.

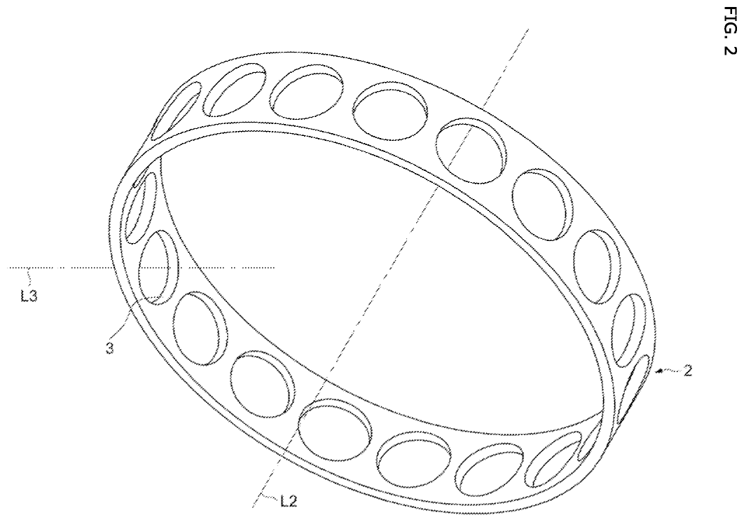

Then, a plurality of pockets 3 are formed within each cut ring, for example by drilling or milling, so as to form cages 2 each having an annular body with a longitudinal axis L2, one of which is depicted in FIG. 2. In the illustrated exemplary embodiment, the cage 2 comprises an annular body with a plurality of pockets 3 of circular shape which are adapted to accommodate balls. As an alternative, the pockets 3 may have different shapes to accommodate rolling elements other than balls, for example cylindrical rollers, taper rollers, needles, etc.

Alternatively, the pockets 3 maybe formed in the tube 1 after the molding and polymerization operation or step and before the step of cutting the tube 1 into a plurality of the rings.

Due to the composition of the material or materials of which it is formed, the cage 2 exhibits properties that permit use of the cage 2 under difficult or relatively extreme conditions, such as high temperatures, high degrees of humidity, or particularly low degrees of humidity. In fact, the cage 2 remains stable from a dimensional point of view and is resistant to heat and to significant variations in the degree of humidity.

As indicated above, a very advantageous example of material for the fibers of the cage 2 is carbon, which notably provides rigidity and lightness in weight, combined with an epoxy resin having a glass transition temperature of between 140° C. and 160° C.

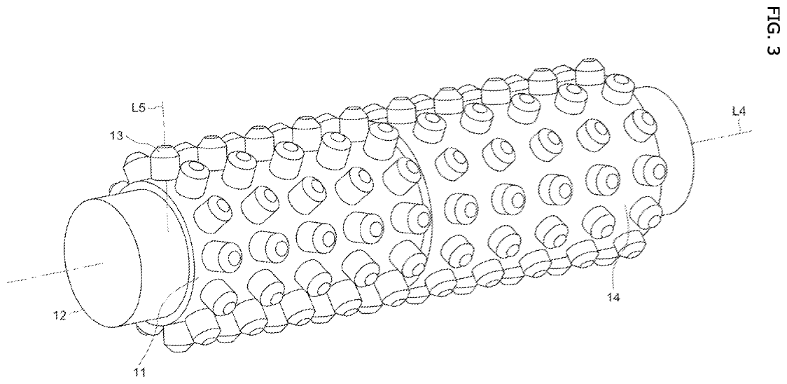

An alternative embodiment of the present invention is illustrated in FIG. 3. In this embodiment, the mandrel comprises a cylinder 12 having a central longitudinal axis L4 and a sleeve 11 mounted on the cylinder 12 and provided with a plurality of protrusions 13 extending radially outwardly from a remainder of the sleeve 11. In the illustrated exemplary embodiment, each protrusion 13 is formed as a circular stud with a radial axis L5, which is used to fabricate or form a cage 2 having circular pockets 3.

The protrusions 13 are arranged in a plurality of circumferential rows, each row comprising a plurality of protrusions 13 spaced apart from one another in the circumferential direction. The plurality of rows are spaced axially apart from each other.

In this embodiment, the fibers are wound on the mandrel equipped with the protrusions 13 so as to obtain the preform of a tube 14. The pockets 3 are thus formed during the following molding and polymerization step.

Then, the method further comprises a subsequent step of separating the cylinder 12 and the sleeve 11 covered by the polymerized tube 14 and then a step of cutting the tube 14 into rings or annular bodies that each constitute a cage 2.

After the cages 2 have been cut from the tube 14, each cage 2 can be introduced into an injection mold to perform over-injection of the skeleton. This makes it possible to obtain the exact shape of the cage, pockets, inner diameter and outer diameter with the aim of reducing the costs created by the machining of the material of the skeleton.

To facilitate the step of separating the cylinder 12 and the sleeve 11, the sleeve 11 is preferably elastically deformable.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A cage for a rolling bearing, the cage circumferentially spacing at least one row of rolling elements, the cage comprising:
an annular body formed of a fiber-reinforced synthetic material having a glass transition temperature equal to or greater than 120° C. and including a plurality of circumferentially spaced pockets, each pocket being configured to receive a separate one of the rolling elements of the row.

2. The cage according to claim 1, wherein the synthetic material is an epoxy resin having a glass transition temperature between 130° C. and 200° C.

3. The cage according to claim 1, wherein the reinforcing fibers are continuous.

4. The cage according to claim 1, wherein the reinforcing fibers include carbon fibers.

5. The cage according to claim 1, wherein the reinforcing fibers include at least one of Kevlar® fibers, flax fibers and Vectran® fibers.

6. A rolling bearing comprising a cage according to claim 1.

7. A method of manufacturing a cage for a rolling bearing, the method comprising the steps of:
forming a cylindrical tube preform by winding continuous fibers pre-impregnated with the synthetic material on a mandrel, the glass transition temperature of the synthetic material being equal to or greater than 120° C.;
molding and polymerizing the tube; and
cutting the formed tube so as to form a plurality of rings, each ring having desired dimensions of a cage.

8. The method according to claim 7, further comprising a step of forming pockets within each one of the plurality of cut rings so as to form a rolling element cage.

9. The method according to claim 7, wherein the step of molding and polymerizing the tube includes forming a plurality of circumferentially spaced pockets within the tube.

10. The method according to claim 9, wherein the mandrel includes a plurality of circumferential rows of protrusions extending radially outwardly from a remainder of the mandrel, each row comprising a plurality of circumferentially spaced apart protrusions and the plurality of rows being spaced apart axially from each other.

11. The cage according to claim 1, wherein the annular body is formed by winding a plurality of continuous fibers pre-impregnated with the synthetic material about a mandrel.
